(19) United States
(12) Patent Application Publication
(10) Pub. No.: US 2023/0206821 A1
(43) Pub. Date: Jun. 29, 2023

(54) SIGNAL PROCESSING METHOD, DISPLAY APPARATUS, TIMING CONTROLLER AND SOURCE DRIVER

(71) Applicants: Haining ESWIN IC Design Co., Ltd., Jiaxing City (CN); Beijing ESWIN Computing Technology Co., Ltd., Beijing (CN)

(72) Inventors: Xiaojun GU, Beijing (CN); Antony KONG, Beijing (CN); Bangran FU, Beijing (CN); Songhe ZHANG, Beijing (CN); Ying WANG, Beijing (CN)

(21) Appl. No.: 18/089,852

(22) Filed: Dec. 28, 2022

(30) Foreign Application Priority Data
Dec. 28, 2021 (CN) 202111622327.9

(51) Int. Cl. G09G 3/20

(52) U.S. Cl. CPC G09G 3/2096; G09G 2310/0275; G09G 2300/0819

(57) ABSTRACT

A signal processing method, a display apparatus, a timing controller, and a source driver. The signal processing method includes: a source driver receiving N pixel data signals supplied by a timing controller and converting the pixel data signals into N display data signals for display on a display panel; obtaining phase difference information of a first phase difference of the N pixel data signals when the N pixel data signals arrive at the source driver; and reducing a second phase difference of the N display data signals supplied by the source driver, according to the phase difference information, wherein N is a positive integer greater than 2. The signal processing method may make the signals achieve an effect of phase synchronization after transmission, improve signal quality, and reduce a difficulty in signal processing.

The present application claims priority of Chinese Patent Application No. 202111622327.9 filed on Dec. 28, 2021, and the above Chinese patent application is incorporated herein by reference in its entirety as part of the present application.

### TECHNICAL FIELD

Embodiments of the present disclosure relate to a signal processing method, a display apparatus, a timing controller, and a source driver.

### BACKGROUND

The mini-LVDS interface is a one-way high-speed serial interface, similar to the LVDS interface, which transmits data signals via differential signal line pairs and is mainly used for transmission of output signals of a timing controller, that is, transmission from the timing controller to a source driver, usually with a clock frequency less than 330 MHz. The mini-LVDS has characteristics of continuous transmission of pixel data of LVDS, as well as characteristics of pure pixel data transmission and dual-edge data acquisition on a rising edge and a falling edge of a clock signal of RSDS. Therefore, in addition to advantages of high-speed transmission, low power consumption, and strong electromagnetic interference resistance, the mini-LVDS interface may also reduce the number of line pairs and simplify PCB circuit design, and reduce product costs. The mini-LVDS is used as the timing controller (driver chip) of a flat panel display apparatus, to provide received pixel data signals to the display panel.

### SUMMARY

At least one embodiment of the present disclosure provides a signal processing method, including: a source driver receiving N pixel data signals supplied by a timing controller and converting the pixel data signals into N display data signals for display on a display panel; obtaining phase difference information of a first phase difference of the N pixel data signals when the N pixel data signals arrive at the source driver; and reducing a second phase difference of the N display data signals supplied by the source driver, according to the phase difference information, N is a positive integer greater than 2.

For example, in the signal processing method provided in at least one embodiment of the present disclosure, reducing the second phase difference of the N display data signals supplied by the source driver, according to the phase difference information, includes: adjusting a timing sequence in which the timing controller sends the N pixel data signals to the source driver, according to the phase difference information, to reduce the first phase difference, the second phase difference decreases with the decrease of the first phase difference.

For example, in the signal processing method provided in at least one embodiment of the present disclosure, the first phase difference is monitored by the source driver to obtain a monitoring result on the phase difference information, and the monitoring result is supplied to the timing controller.

For example, in the signal processing method provided in at least one embodiment of the present disclosure, the phase difference information is preset information.

For example, in the signal processing method provided in at least one embodiment of the present disclosure, reducing the second phase difference of the N display data signals supplied by the source driver, according to the phase difference information, includes: monitoring the first phase difference by the source driver, to obtain a monitoring result on the phase difference information; and adjusting a timing sequence in which the source driver sends the N display data signals to the display panel, according to the monitoring result, to reduce the second phase difference.

For example, in the signal processing method provided in at least one embodiment of the present disclosure, the N pixel data signals are low voltage differential signals.

For example, in the signal processing method provided in at least one embodiment of the present disclosure, the first phase difference is a phase difference between two pixel data signals in the N pixel data signals, the phase difference between the two pixel data signals is larger than or equal to a phase difference between any two pixel data signals in the N pixel data signals.

For example, in the signal processing method provided in at least one embodiment of the present disclosure, the second phase difference is a phase difference between two display data signals in the N display data signals, the phase difference between the two display data signals is larger than or equal to a phase difference between any two display data signals in the N display data signals.

For example, in the signal processing method provided in at least one embodiment of the present disclosure, adjusting the timing sequence in which the timing controller sends the N pixel data signals to the source driver, according to the phase difference information, to reduce the first phase difference, comprises: adjusting the timing sequence in which the timing controller sends the N pixel data signals to the source driver, according to the phase difference information, to reduce the first phase difference to less than a first threshold.

At least one embodiment of the present disclosure provides a timing controller, comprising a signal transmitter, a signal receiver, and a signal adjuster, wherein the signal transmitter is configured to supply N pixel data signals to a source driver; the signal receiver is configured to receive phase difference information of a first phase difference of the N pixel data signals when the N pixel data signals arrive at the source driver; and the signal adjuster is configured to adjust a timing sequence in which the signal transmitter sends the N pixel data signals to the source driver, according to the phase difference information, so as to reduce the first phase difference, wherein N is a positive integer greater than 2.

For example, in the timing controller provided in at least one embodiment of the present disclosure, the first phase difference is a phase difference between two pixel data signals in the N pixel data signals, the phase difference between the two pixel data signals is larger than or equal to a phase difference between any two pixel data signals in the N pixel data signals.

For example, in the timing controller provided in at least one embodiment of the present disclosure, the timing controller according to claim 10, wherein the N pixel data signals are low voltage differential signals.

At least one embodiment of the present disclosure provides a source driver, comprising a receiver and a monitor, wherein the receiver is configured to receive N pixel data signals from a timing controller, the monitor is configured to monitor phase difference information of a first phase difference of the N pixel data signals when the N pixel data signals arrive at the source driver, to obtain a monitoring result, and supply the monitoring result to the timing controller, so that the timing controller adjusts a timing sequence in which the timing controller sends the N pixel data signals to the source driver according to the monitoring result, wherein N is a positive integer greater than 2.

For example, the source driver provided in at least one embodiment of the present disclosure further comprising a display data signal adjuster, wherein the display data signal adjuster is configured to adjust a timing sequence in which the source driver sends N display data signals, converted from the N pixel data signals, to a display panel according to the monitoring result, so as to reduce a second phase difference of the N display data signals.

For example, in the source driver provided in at least one embodiment of the present disclosure, the first phase difference is a phase difference between two pixel data signals in the N pixel data signals, the phase difference between the two pixel data signals is larger than or equal to a phase difference between any two pixel data signals in the N pixel data signals; the second phase difference is a phase difference between two display data signals in the N display data signals, the phase difference between the two display data signals is larger than or equal to a phase difference between any two display data signals in the N display data signals.

For example, in the source driver provided in at least one embodiment of the present disclosure, the N pixel data signals are low voltage differential signals.

At least one embodiment of the present disclosure provides a display apparatus, comprising a display panel, a source driver and the timing controller according to at least one embodiment of the present disclosure, the source driver is coupled with the display panel, and configured to convert N pixel data signals into N display data signals, and supply the N display data signals to the display panel for display; and the timing controller is coupled with the source driver to supply the N pixel data signals to the source driver.

For example, in the display apparatus provided in at least one embodiment of the present disclosure, the source driver comprises a receiver and a monitor, the receiver is configured to receive the N pixel data signals from the timing controller; the monitor is configured to monitor phase difference information of a first phase difference of the N pixel data signals when the N pixel data signals arrive at the source driver to obtain a monitoring result, and to supply the monitoring result to the timing controller.

For example, in the display apparatus provided in at least one embodiment of the present disclosure, the source driver further comprises a display data signal adjuster, the display data signal adjuster is configured to adjust a timing sequence in which the source driver sends the N display data signals to the display panel, according to the monitoring result, so as to reduce a second phase difference of the N display data signals.

At least one embodiment of the present disclosure provides a display apparatus, comprising a display panel, the source driver according to at least one embodiment of the present disclosure and a timing controller, the source driver is coupled with the display panel, and configured to convert the N pixel data signals into N display data signals, and supply the N display data signals to the display panel for display; and the timing controller is coupled with the source driver to supply the N pixel data signals to the source driver.

### BRIEF DESCRIPTION OF THE DRAWINGS

In order to explain the technical solutions of embodiments of the present disclosure more clearly, the drawings of the embodiments will be briefly introduced below. Obviously, the drawings in the following description only relate to some embodiments of the present disclosure, rather than limit the present disclosure.

FIG. 1 shows a structural schematic diagram of a display apparatus;

FIG. 2 shows a schematic diagram of a 3-channel 6-bit pixel data signal format;

FIG. 3 shows a schematic flow chart of a signal processing method provided by at least one embodiment of the present disclosure;

FIG. 4 shows a schematic diagram of a method of step S303 in FIG. 3;

FIG. 5 shows a schematic diagram of another method of step S303 in FIG. 3;

FIG. 6 shows a schematic diagram of another method of step S303 in FIG. 3;

FIG. 7 shows a schematic block diagram of a display apparatus provided by at least one embodiment of the present disclosure;

FIG. 8 shows a schematic block diagram of a timing controller provided by at least one embodiment of the present disclosure;

FIG. 9 shows a schematic block diagram of a source driver provided by at least one embodiment of the present disclosure; and

FIG. 10 shows a schematic diagram of a display apparatus according to at least one embodiment of the present disclosure.

### DETAILED DESCRIPTION

In order to make objects, technical details and advantages of the embodiments of the disclosure apparent, the technical solutions of the embodiments will be described in a clearly and fully understandable way in connection with the drawings related to the embodiments of the present disclosure. Apparently, the described embodiments are just a part but not all of the embodiments of the present disclosure. Based on the described embodiments herein, those skilled in the art can obtain other embodiment(s), without any inventive work, which should be within the scope of the present disclosure.

Unless otherwise defined, all the technical and scientific terms used herein have the same meanings as commonly understood by one of ordinary skill in the art to which the present disclosure belongs. The terms “first,” “second,” etc., which are used in the present disclosure, are not intended to indicate any sequence, amount or importance, but distinguish various components. Also, the terms such as “a,” “an,” “the,” etc., are not intended to limit the amount, but indicate the existence of at least one. The terms “comprise,” “comprising,” “include,” “including,” etc., are intended to specify that the elements or the objects stated before these terms encompass the elements or the objects and equivalents thereof listed after these terms, without excluding other elements or objects. The terms such as “connection” or “connecting” etc., are not limited to physical or mechanical connection, but may include electrical connection, whether direct or indirect. The terms “up”, “down”, “left”, “right” etc., are only used to represent the relative position relationship. When the absolute position of the described object changes, the relative position relationship may also change accordingly.

FIG. 1 shows a structural schematic diagram of a display apparatus.

As shown in FIG. 1, the display apparatus 100 includes a timing controller 101 and a display panel 102. The display panel 102 includes a plurality of sub-pixel arrays arranged in an array, a plurality of source drivers 103, and a gate driver. The sub-pixel array includes, for example, gate lines corresponding to a plurality of rows of sub-pixels and data lines corresponding to a plurality of columns of sub-pixels. The gate driver circuit is arranged on a side of the display panel 102, and supplies driving signals to a plurality of gate lines of the sub-pixel array under control of the timing controller 101. The source driver 103, which may also be referred to as a data driver, is arranged on the other side of the display panel 102, and supplies display pixel signals to a plurality of data lines of the sub-pixel array, under control of the timing controller 101. For example, the display pixel signals include a red display pixel signal corresponding to a red sub-pixel, a green display pixel signal corresponding to a green sub-pixel, and a blue display pixel signal corresponding to a blue sub-pixel. For example, one source driver 103 corresponds to some of the sub-pixel columns in the display panel, for example, each output port of the source driver 103 corresponds to a data line (e.g., a column of sub-pixels). For example, the display panel may be a Liquid Crystal Display (LCD) panel, an Organic Light Emitting Diode Display (OLED) panel, a quantum dot display panel, or the like.

The timing controller 101 is configured to receive an image signal (e.g., a video signal) from a video source such as a network, a memory, or the like; for example, according to interface type, the image signal may be an LVDS signal, a Vx1 signal, or an eDP signal. The timing controller 101 may convert the received image signal into a mini-LVDS signal (mini-low voltage differential signal), then supply the mini-LVDS signal to the source driver 103, and supply a clock signal, a row synchronization signal, a field synchronization signal, etc. to the gate driver and the source driver, thereby driving the gate driver and the source driver for display operation.

For example, the timing controller 101 includes a mini-LVDS transmitter; and the timing controller 101 is coupled with the source driver 103 through the mini-LVDS interface. From a perspective of topology, the mini-LVDS interface is a dual-bus structure; the two buses respectively carries video data of a left half panel and video data of a right half panel of the display panel 102, respectively expressed as LLV and RLV. Each bus contains a plurality of pairs of transmission lines, and each pair of transmission lines carries video data signals (pixel data signals). In addition to the differential signal pair carrying video data, the mini-LVDS further consists of two signals, TP1 signal and POL signal. TP1 signal and POL signal are control signals, POL signal is a data polarity reversal control signal, which controls polarity reversal of the data signal output by the source driver through switching of high and low levels; TP1 signal is a control signal for data transmission, whose rising edge latches data input to the source driver and POL polarity signal, and falling edge controls data release to the display panel. Each group of signal pairs is accompanied by a clock signal pair; the clock signal pair is a differential signal pair just like the video data signal, and signals are transmitted on both a rising edge and a falling edge of the clock signal. The number of transmission line pairs is related to pixel depth and data format; and 3 pairs of transmission lines (LLV0 to 2, RLV0 to 2) or 6 pairs of transmission lines (LLV0 to 5, RLV0 to 5) may be set according to actual design needs.

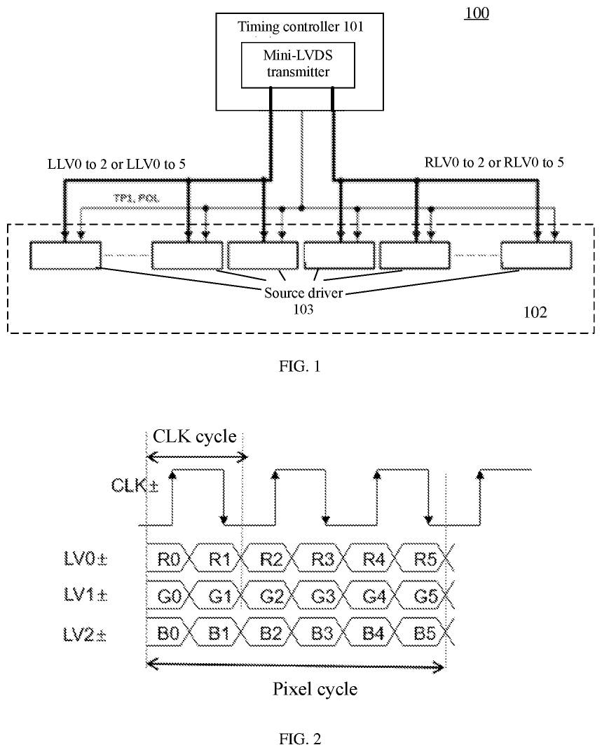

FIG. 2 shows a schematic diagram of a 3-channel 6-bit pixel data signal format.

As shown in FIG. 2, corresponding to the image signal, for three color channels of red (R), green (G) and blue (B), the timing controller 101 respectively transmits the three types of pixel data signals respectively through 3 pairs of transmission lines; and the 3 pairs of transmission lines are respectively LV0±, LV1± and LV2±. In a pixel cycle, 6-bit pixel data signals (R0 to R5, G0 to G5, B0 to B5) are transmitted; and pixel data signals are transmitted on both the rising edge and the falling edge of the clock signal (CLK±).

It may be seen from FIG. 2 that there is a certain multiple relationship between frequency of the clock signal and frequency of the pixel data signal; with respect to the pixel data signal with a pixel depth of 18 bits (3*6 bits) shown in FIG. 2, 6 bits of pixel data signals are sampled in each clock cycle through clock dual-edge sampling, so the frequency of the clock signal is 3 times the frequency of the pixel data signal. It should be noted that, according to an encoding mode of the pixel data signal, for example, being encoded into 6 bits, 8 bits or 10 bits, 6 bits of pixel data signals, 8 bits of pixel data signals or 10 bits of pixel data signals may be transmitted within a pixel cycle; and the number of code bits of the pixel data signals will not be limited in the present disclosure.

From the timing controller 101 to the display panel 102, the mini-LVDS transmission line is implemented by using stripline or microstrip topology; different impedances and lengths of lines affect signal transmission quality. Different PCB thicknesses and line impedances will affect signal transmission quality, for example, cause a phase difference between the signals sent by the timing controller and the signal received by the display panel, which increases difficulties in signal reception and processing.

At least one embodiment of the present disclosure provides a signal processing method, including: a source driver receiving N pixel data signals supplied by a timing controller and converting the pixel data signals into N display data signals for display on a display panel; obtaining phase difference information of a first phase difference of the N pixel data signals when the N pixel data signals arrive at the source driver; and reducing a second phase difference of the N display data signals supplied by the source driver, according to the phase difference information, N is a positive integer greater than 2.

The signal processing method may make the signals achieve an effect of phase synchronization after transmission, improve signal quality, and reduce a difficulty in signal processing.

It should be noted that at least one embodiment of the present disclosure is illustrated by taking that an output end of the timing controller (i.e., a connection end with the source driver of the display panel) includes the mini-LVDS interface as an example; with respect to other types of interfaces having a phase difference between the signals sent by the timing controller and the signal received by the display panel, the signal processing method provided by at least one embodiment of the present disclosure may also be applied to reduce signal delay.

At least one embodiment of the present disclosure further provides a display panel, a timing controller, and a source driver corresponding to the above-described signal processing method.

The embodiments of the present disclosure will be described in detail below in conjunction with the accompanying drawings, but the present disclosure is not limited to these specific embodiments.

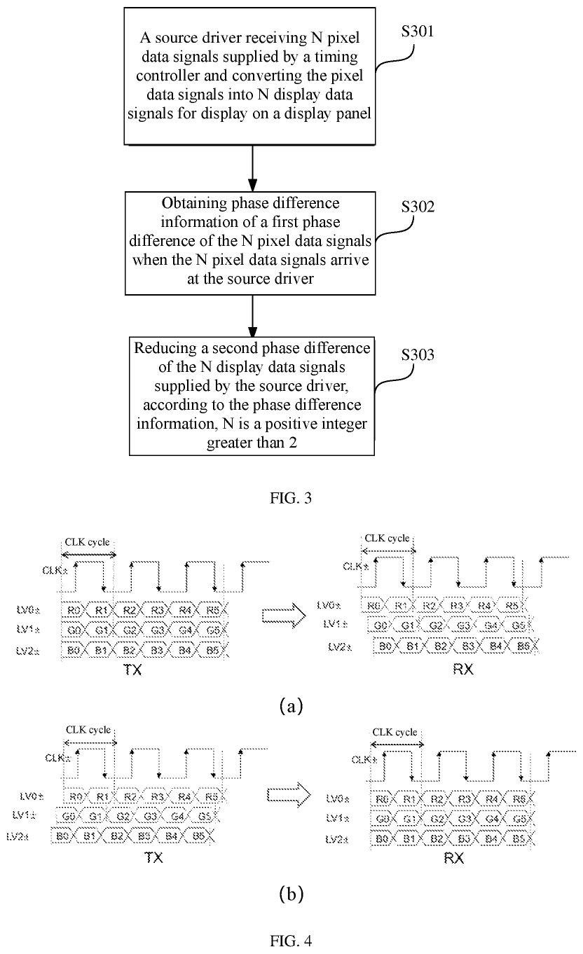

FIG. 3 shows a schematic flow chart of a signal processing method provided by at least one embodiment of the present disclosure.

As shown in FIG. 3, the signal processing method includes steps S301 to S303 below.

Step S301: a source driver receiving N pixel data signals supplied by a timing controller and converting the pixel data signals into N display data signals for display on a display panel.

For example, the N pixel data signals are Low Voltage Differential Signals (LVDS), for example, mini-LVDS signals. The N pixel data signals are transmitted through N color channels respectively.

Main functions of the source driver include receiving pixel data signals and control signals supplied by the front-end Timing Controller (TCON), converting the pixel data signals into corresponding display data signals (analog gray scale voltage signals) through Digital-Analog Conversion (DAC), and inputting the display data signals into pixels of the liquid crystal display panel. The display panel includes a plurality of sub-pixels arranged in an array of m rows and n columns, m and n are positive integers. For example, the display panel may be a Liquid Crystal Display (LCD) panel, an Organic Light Emitting Diode Display (OLED) panel, a quantum dot display panel, or the like; for example, each pixel in the pixel array of the display panel includes RGB sub-pixels, and these RGB sub-pixels respectively receive pixel data signals of RGB color channels.

Step S302: obtaining phase difference information of a first phase difference of the N pixel data signals when the N pixel data signals arrive at the source driver.

For example, the first phase difference is a phase difference of the pixel data signals.

The pixel data signals arrive at the source driver through transmission by the transmission lines; influence of impedances and lengths of different transmission lines will cause delay of the pixel data signals, thereby causing a phase difference between the pixel data signals.

Step S303: reducing a second phase difference of the N display data signals supplied by the source driver, according to the phase difference information, N is a positive integer greater than 2.

After receiving the pixel data signals, the source driver will convert the pixel data signals into the display data signals, and send the display data signals to the corresponding data line of the display panel for display.

For example, in some embodiments of the present disclosure, step S303 may include: adjusting a timing sequence in which the timing controller sends the N pixel data signals to the source driver, according to the phase difference information, to reduce the first phase difference, the second phase difference decreases with the decrease of the first phase difference.

For example, the phase difference information is preset information. In a test phase before actual transmission of the pixel data signals, the phase difference information of the first phase difference is detected, and the phase difference information is given in advance as preset information, for example, stored in the timing controller, or stored in a storage apparatus read by the timing controller. In this way, the pixel data signals are adjusted by using the phase difference information before the timing controller actually transmits the pixel data signals; and after the adjusted pixel data signals are delayed by the transmission lines, the pixel data signals received at the source driver may achieve phase synchronization. A schematic diagram of the method is shown in FIG. 4.

FIG. 4 shows a schematic diagram of a method of step S303 in FIG. 3.

As shown in FIG. 4, (a) in FIG. 4 shows delay of the pixel data signals arriving at the source driver before adopting the method according to the embodiment of the present disclosure. The three channels LV0±, LV1± and LV2±respectively transmit R signal, G signal and B signal. Phases of the pixel data signals of the three color channels are synchronized at the timing controller. After transmission by the transmission lines, phases of the pixel data signal received at the source driver are delayed, so the phases of the pixel data signals of the three color channels are no longer synchronized, resulting in the first phase difference as described above. It may be seen that the pixel data signals corresponding to LV0±, LV1± and LV2± are sequentially delayed. Here, the first phase difference is defined as a phase difference between pixel data signals of two color channels with a largest phase difference among the pixel data signals of the plurality of color channels; with respect to the three color channels, three phase differences may be obtained by combination; then, the first phase difference is a maximum value of the three phase differences, which is the phase difference between LV0± and LV2± in FIG. 4 (a). It should be noted that other delay modes may also be used, for example, the pixel data signals corresponding to LV2±, LV0± and LV1± are delayed sequentially. For example, the first phase difference is a phase difference between two pixel data signals in the N pixel data signals, the phase difference between the two pixel data signals is larger than or equal to a phase difference between any two pixel data signals in the N pixel data signals.

Diagram (b) in FIG. 4 shows delay of the pixel data signals arriving at the source driver after adopting the method according to at least one embodiment of the present disclosure. At the timing controller, the pixel data signals are adjusted in advance by using the phase difference information in (a) of FIG. 4. For example, in (a) of FIG. 4, the pixel data signal corresponding to LV1± is delayed by x relative to the pixel data signal corresponding to LV0±, and the pixel data signal corresponding to LV2± is delayed by y relative to the pixel data signal corresponding to LV0±; at the timing controller, the pixel data signals of the three channels have phases not synchronized with each other when being sent. Therefore, in (b) of FIG. 4, at the timing controller, the pixel data signal corresponding to LV1± is advanced by x, and the pixel data signal corresponding to LV2± is advanced by y, so that when the pixel data signals arrive at the source driver after delay by the transmission lines, the first phase difference of these pixel data signals is reduced, for example, the phases become basically synchronized with each other; in the case where these pixel data signals are synchronized, the first phase difference is 0. Reduction of the first phase difference helps to improve signal quality, thereby helping to improve display quality of the display panel.

Through the above-described phase deviation correction technology, the pixel data signals corresponding to LV0±, LV1± and LV2± may achieve phase synchronization (or basic synchronization). The standard of phase synchronization is that the phase difference of the pixel data signals is less than a certain threshold (a first threshold). For example, the threshold may be ±625 ps, for example, may be ±312 ps.

In some embodiments of the present disclosure, the reducing the first phase difference may include: reducing the first phase difference so that the first phase difference is less than ±625 ps, for example, may be ±312 ps.

For example, in some embodiments of the present disclosure, the first phase difference is monitored by the source driver to obtain a monitoring result on the phase difference information, and the monitoring result is supplied to the timing controller.

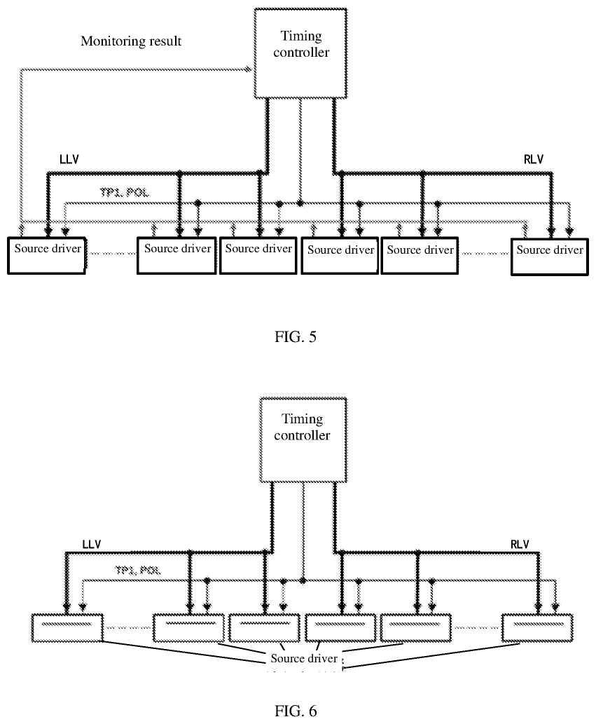

Due to long-term use of the display apparatus and changes of use environment, the impedances of the transmission lines transmitting the pixel data signals may also change dynamically, resulting in that the preset phase difference information may not be able to meet needs of practical applications for a long time. Therefore, in at least one embodiment, the first phase difference may be monitored in real time by the source driver, to feed back the monitoring result on the phase difference information to the timing controller in real time. Therefore, the timing controller may adjust the phase difference of the pixel data signals in real time according to the monitoring result, to reduce the first phase difference, thereby improving signal quality and display quality. For example, the method according to this embodiment is shown in FIG. 5.

FIG. 5 shows a schematic diagram of another method of step S303 in FIG. 3.

As shown in FIG. 5, an arrow from the source driver to the timing controller indicates the monitoring result of the phase difference information fed back to the timing controller by the source driver in real time; and the timing controller adjusts the phases of the pixel data signals sent out in real time according to the monitoring result. The source driver monitors the cycle of the first phase difference in real time, to select according to needs, for example, 1 second, 10 seconds, 30 seconds, etc. which will not be limited in the embodiments of the present disclosure in terms of the meaning of “real time”.

Through real-time feedback of the monitoring result, the timing controller may adjust the phases in real time, so as to ensure that the phases of the pixel data signals actually transmitted to the source driver may be synchronized in real time.

Similarly, the standard for achieving phase synchronization is that the phase difference of the pixel data signals is less than a certain threshold (a first threshold). For example, the threshold value is ±625 ps, for example, may be ±312 ps.

For example, in some embodiments of the present disclosure, step S303 may include: monitoring the first phase difference by the source driver, to obtain the monitoring result on the phase difference information; and adjusting the timing sequence in which the source driver sends the N display data signals to the display panels, according to the monitoring result, to reduce the second phase difference.

For example, the second phase difference is a phase difference of the display data signals, which is defined as a phase difference between display data signals of two color channels with a largest phase difference among the display data signals of the plurality of color channels; with respect to the three color channels, three phase differences may be obtained by combination; then, the second phase difference is the maximum value of the three phase differences. For example, the second phase difference is a phase difference between two display data signals in the N display data signals, the phase difference between the two display data signals is larger than or equal to a phase difference between any two display data signals in the N display data signals.

Because a reception situation of each source driver is different, especially for a large-sized display panel, and a length of a line from the timing controller to each source driver is different, phase difference information of pixel data signals arriving at different source drivers is different. Therefore, after converting the pixel data signals into the display data signals by the source drivers and before sending the display data signals to the display panel, the source drivers may perform phase correction on the display data signals again, to reduce the second phase difference of the display data signals supplied to the display panel, which, thus, may further improve quality of signals supplied to the display panel and improve display quality. The exemplary method is shown in FIG. 6.

FIG. 6 shows a schematic diagram of another exemplary method of step S303 in FIG. 3. As shown in FIG. 6, a horizontal line in the source driver represents an apparatus for phase automatic correction in the source driver. After receiving pixel data signals from a plurality of color channels sent by the timing controller, the source driver needs to convert these pixel data signals into display data signals of corresponding color channels. Before sending the display data signals to the display panel, the source driver performs phase correction on these display data signals; for example, the phase automatic correction apparatus in the source driver may monitor the first phase difference to obtain a monitoring result on the phase difference information in real time, and then perform real-time phase correction on the display data signals according to the monitoring result.

Through real-time phase correction of the display data signals at the source driver, phase synchronization (or basic synchronization) between the display data signals of the respective color channels supplied to the display panel may be further ensured, thereby improving signal quality and display quality.

It should be noted that the method shown in FIG. 4 and the method shown in FIG. 5 may be used together, and the method shown in FIG. 6 may be used alone, or may also be used together with the methods shown in FIG. 4 and FIG. 5. The three technologies have a best effect when used together, and may achieve phase synchronization as much as possible.

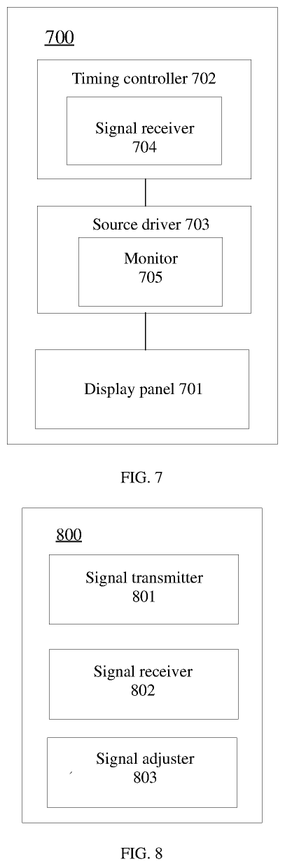

FIG. 7 shows a schematic block diagram of a display apparatus 700 provided by at least one embodiment of the present disclosure; and the display apparatus may be configured to execute the signal processing method shown in FIG. 3.

As shown in FIG. 7, the display apparatus 700 includes a display panel 701, a timing controller 702, and a source driver 703; the timing controller 702 includes a signal receiver 704; and the source driver 703 includes a monitor 705.

The timing controller 702 is coupled with the source driver 703, to supply N pixel data signals to the source driver 703.

The source driver 703 is coupled with the display panel 701, to convert the N pixel data signals into N display data signals, and supply the N display data signals to the display panel 701 for display.

The timing controller 702 is configured to adjust a timing sequence in which the timing controller 702 sends the N pixel data signals to the source driver 703, according to phase difference information of a first phase difference of the N pixel data signals when the N pixel data signals arrive at the source driver 703, so as to reduce the first phase difference of the N pixel data signals when the N pixel data signals arrive at the source driver 703.

The source driver 703 is configured to adjust a timing sequence in which the source driver 703 sends the N display data signals to the display panel 701, so as to reduce a second phase difference, N is a positive integer greater than 2.

The signal receiver 704 is configured to receive the phase difference information of the first phase difference of the N pixel data signals when the N pixel data signals arrive at the source driver 703.

The monitor 705 is configured to monitor the first phase difference to obtain a monitoring result on the phase difference information, and supply the monitoring result to the timing controller 702, so that the timing controller 702 adjusts a timing sequence in which the timing controller 702 sends the N pixel data signals to the source driver 703 according to the monitoring result, so as to reduce the first phase difference.

For example, the timing controller 702 and the source driver 703, etc. of the display apparatus 700 may be implemented by adopting hardware, software, firmware and any combination thereof, which will not be limited in the present disclosure. As required, the display apparatus 700 further includes a gate driver, a voltage managing module, a modem, etc., which will not be limited in the embodiments of the present disclosure.

Technical effects of the display apparatus 700 are the same as the technical effects of the signal processing method shown in FIG. 3, and no details will be repeated here.

FIG. 8 shows a schematic block diagram of a timing controller 800 provided by at least one embodiment of the present disclosure.

As shown in FIG. 8, the timing controller 800 includes a signal transmitter 801, a signal receiver 802, and a signal adjuster 803.

The signal transmitter 801 is configured to supply N pixel data signals to the source driver.

The signal receiver 802 is configured to receive phase difference information of a first phase difference of the N pixel data signals when the N pixel data signals arrive at the source driver.

The signal adjuster 803 is configured to adjust a timing sequence in which the signal transmitter 801 sends the N pixel data signals to the source driver, according to the phase difference information, so as to reduce the first phase difference, N is a positive integer greater than 2.

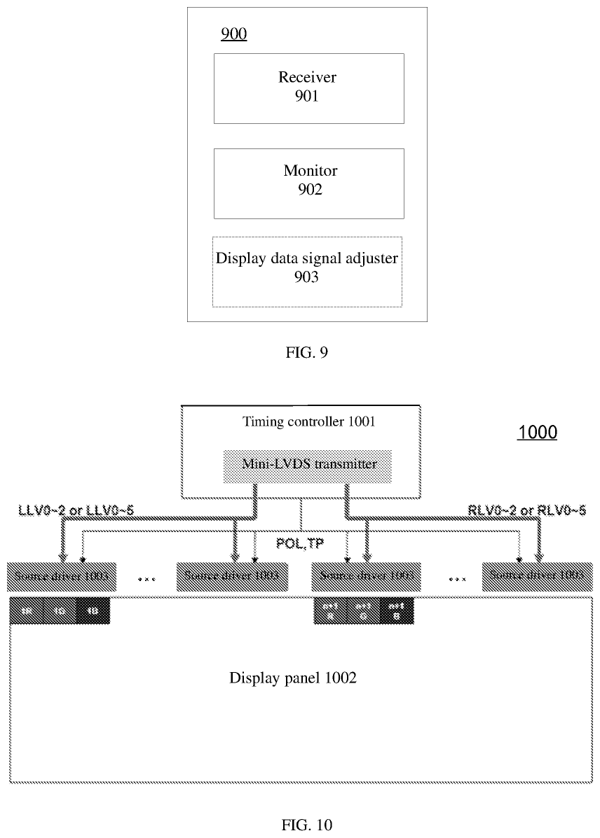

FIG. 9 shows a schematic block diagram of a source driver 900 provided by at least one embodiment of the present disclosure.

As shown in FIG. 9, the source controller 900 includes a receiver 901 and a monitor 902.

The receiver 901 is configured to receive N pixel data signals from a timing controller.

The monitor 902 is configured to monitor phase difference information of a first phase difference of the N pixel data signals when the N pixel data signals arrive at the source driver 900, to obtain a monitoring result, and supply the monitoring result to the timing controller, N is a positive integer greater than 2.

For example, in some embodiments of the present disclosure, the source driver 900 may further include a display data signal adjuster 903.

The display data signal adjuster 903 is configured to adjust a timing sequence in which the source driver 900 sends the N display data signals converted from the N pixel data signals to the display panel, according to the monitoring result, so as to reduce a second phase difference of the N display data signals.

FIG. 10 shows a schematic diagram of a display apparatus 1000 according to at least one embodiment of the present disclosure.

As shown in FIG. 10, the display apparatus 1000 is configured to implement the signal processing method according to at least one embodiment of the present disclosure. The display apparatus 1000 includes a timing controller 1001, a source driver 1003, and a display panel 1002. An output end of the timing controller 1001 adopts a mini-LVDS interface, and accordingly, a mini-LVDS transmitter is located inside the timing controller 1001; the mini-LVDS transmission line contains dual buses, respectively LLV and RLV. The timing controller 1001 is coupled with the source driver 1003 through the mini-LVDS, to supply pixel data signals to the source driver 1003. The source driver 1003 is coupled with the pixel array of the display panel 1002, to convert the pixel data signals of respective color channels into the display data signals of the corresponding color channels, and supply the display data signals of the respective color channels to sub-pixels of corresponding colors of each pixel of the display panel 1002 for display; FIG. 10 shows the pixel data signals in RGB format, so the pixel data signals with three color channels are correspondingly supplied to the RGB sub-pixels of the pixel.

The embodiment of the signal processing method provided by at least one embodiment of the present disclosure will be briefly described below in conjunction with the display apparatus shown in FIG. 10; and the foregoing description may be referred to for details.

Modes of adjusting the timing sequence of the pixel data signals at the timing controller 1001 to synchronize phases of the pixel data signals at the source driver 1003 include:

A first mode: in a test phase before actual transmission of the pixel data signals, the timing controller 1001 supplies N (N is a positive integer greater than 2) pixel data signals and transmits the pixel data signals to the source driver 1003 through the mini-LVDS; the source driver 1003 receives the phase difference information of the N pixel data signals and supplies the detected phase difference information of the phase difference to the timing controller 1001 as preset information; the timing controller 1001 adjusts timing sequence of the N pixel data signals transmitted to the source driver 1003 according to the preset phase difference information, to reduce the phase difference.

A second mode: the source driver 1003 monitors the phase difference of the pixel data signals in real time to obtain a monitoring result of the phase difference information, and feeds back the monitoring result to the timing controller 1001 in real time; and the timing controller 1001 adjusts timing sequence of the N pixel data signals in real time according to the monitoring result.

For another example, the timing sequence of the display data signals may be adjusted at the source driver 1003 to synchronize the phases of the display data signals sent to the display panel 1002.

Firstly, the source driver 1003 converts the N pixel data signals into N display data signals used by the display panel 1002 for display; then, the source driver 1003 obtains the monitoring result on the phase difference information by monitoring the phase difference of the pixel data signals; and next, the source driver 1003 adjusts the timing sequence of sending the N display data signals to the display panel 1002 according to the monitoring result, to reduce the phase difference.

The phase synchronization correction technology at the timing controller 1001 and the phase synchronization correction technology at the source driver 1003 may be adopted simultaneously, to further ensure that the effect of phase synchronization is achieved. The phase synchronization correction technology at the timing controller 1001 or the phase synchronization correction technology at the source driver 1003 may also be adopted separately.

For this disclosure, the following statements should be noted:

(1) The accompanying drawings involve only the structure(s) in connection with the embodiment(s) of the present disclosure, and other structure(s) can be referred to common design(s).

(2) In case of no conflict, embodiments of the present disclosure and features in the embodiments can be combined to obtain new embodiments.

The above are only specific implementations of the present disclosure, but the protection scope of the present disclosure is not limited thereto. The protection scope of the present disclosure should be subject to the protection scope of the claims.

1. A signal processing method, comprising:
a source driver receiving N pixel data signals supplied by a timing controller and converting the N pixel data signals into N display data signals for display on a display panel;
obtaining phase difference information of a first phase difference of the N pixel data signals when the N pixel data signals arrive at the source driver; and
reducing a second phase difference of the N display data signals supplied by the source driver, according to the phase difference information, wherein N is a positive integer greater than 2.

2. The signal processing method according to claim 1, wherein reducing the second phase difference of the N display data signals supplied by the source driver, according to the phase difference information, comprises:
adjusting a timing sequence in which the timing controller sends the N pixel data signals to the source driver, according to the phase difference information, to reduce the first phase difference, wherein the second phase difference decreases with the decrease of the first phase difference.

3. The signal processing method according to claim 2, wherein the first phase difference is monitored by the source driver to obtain a monitoring result on the phase difference information, and the monitoring result is supplied to the timing controller.

4. The signal processing method according to claim 1, wherein the phase difference information is preset information.

5. The signal processing method according to claim 1, wherein reducing the second phase difference of the N display data signals supplied by the source driver, according to the phase difference information, comprises:
monitoring the first phase difference by the source driver, to obtain a monitoring result on the phase difference information; and
adjusting a timing sequence in which the source driver sends the N display data signals to the display panel, according to the monitoring result, to reduce the second phase difference.

6. The signal processing method according to claim 1, wherein the N pixel data signals are low voltage differential signals.

7. The signal processing method according to claim 1, wherein
the first phase difference is a phase difference between two pixel data signals in the N pixel data signals, the phase difference between the two pixel data signals is larger than or equal to a phase difference between any two pixel data signals in the N pixel data signals.

8. The signal processing method according to claim 1, wherein
the second phase difference is a phase difference between two display data signals in the N display data signals, the phase difference between the two display data signals is larger than or equal to a phase difference between any two display data signals in the N display data signals.

9. The signal processing method according to claim 2, wherein adjusting the timing sequence in which the timing controller sends the N pixel data signals to the source driver, according to the phase difference information, to reduce the first phase difference, comprises:
adjusting the timing sequence in which the timing controller sends the N pixel data signals to the source driver, according to the phase difference information, to reduce the first phase difference to less than a first threshold.

10. A timing controller, comprising a signal transmitter, a signal receiver, and a signal adjuster,
wherein the signal transmitter is configured to supply N pixel data signals to a source driver;
the signal receiver is configured to receive phase difference information of a first phase difference of the N pixel data signals when the N pixel data signals arrive at the source driver; and
the signal adjuster is configured to adjust a timing sequence in which the signal transmitter sends the N pixel data signals to the source driver, according to the phase difference information, so as to reduce the first phase difference, wherein N is a positive integer greater than 2.

11. The timing controller according to claim 10, wherein
the first phase difference is a phase difference between two pixel data signals in the N pixel data signals, the phase difference between the two pixel data signals is larger than or equal to a phase difference between any two pixel data signals in the N pixel data signals.

12. The timing controller according to claim 10, wherein the N pixel data signals are low voltage differential signals.

13. A source driver, comprising a receiver and a monitor, wherein
the receiver is configured to receive N pixel data signals from a timing controller,
the monitor is configured to monitor phase difference information of a first phase difference of the N pixel data signals when the N pixel data signals arrive at the source driver, to obtain a monitoring result, and supply the monitoring result to the timing controller, so that the timing controller adjusts a timing sequence in which the timing controller sends the N pixel data signals to the source driver according to the monitoring result,
wherein N is a positive integer greater than 2.

14. The source driver according to claim 13, further comprising a display data signal adjuster, wherein
the display data signal adjuster is configured to adjust a timing sequence in which the source driver sends N display data signals, converted from the N pixel data signals, to a display panel according to the monitoring result, so as to reduce a second phase difference of the N display data signals.

15. The source driver according to claim 14, wherein
the first phase difference is a phase difference between two pixel data signals in the N pixel data signals, the phase difference between the two pixel data signals is larger than or equal to a phase difference between any two pixel data signals in the N pixel data signals;
the second phase difference is a phase difference between two display data signals in the N display data signals, the phase difference between the two display data signals is larger than or equal to a phase difference between any two display data signals in the N display data signals.

16. The source driver according to claim 13, wherein the N pixel data signals are low voltage differential signals.

17. A display apparatus, comprising:
a display panel;
a source driver, coupled with the display panel, and configured to convert N pixel data signals into N display data signals, and supply the N display data signals to the display panel for display; and
the timing controller according to claim 10, coupled with the source driver to supply the N pixel data signals to the source driver.

18. The display apparatus according to claim 17, wherein the source driver comprises:
a receiver, configured to receive the N pixel data signals from the timing controller;
a monitor, configured to monitor phase difference information of a first phase difference of the N pixel data signals when the N pixel data signals arrive at the source driver to obtain a monitoring result, and to supply the monitoring result to the timing controller.

19. The display apparatus according to claim 18, wherein the source driver further comprises:
a display data signal adjuster, configured to adjust a timing sequence in which the source driver sends the N display data signals to the display panel, according to the monitoring result, so as to reduce a second phase difference of the N display data signals.

20. A display apparatus, comprising:
a display panel;
the source driver according to claim 13, coupled with the display panel, and configured to convert the N pixel data signals into N display data signals, and supply the N display data signals to the display panel for display; and
a timing controller, coupled with the source driver to supply the N pixel data signals to the source driver.
